(19) United States
(12) Patent Application Publication
(10) Pub. No.: US 2006/0005520 A1
(43) Pub. Date: Jan. 12, 2006

(54) Trimming apparatus and mower deck comprising same

(76) Inventor: Joe Weidman, Edgar, WI (US)

Correspondence Address: SIMON, GALASSO & FRANTZ PLC., P.O. Box 26503, Austin, TX, 78755-0503, US

(21) Appl. No.: 10/887,696

(22) Filed: Jul. 9, 2004

(51) Int. Cl. A01D 34/00

(52) U.S. Cl. 56/12.7

(57) ABSTRACT

A mower comprises a mover deck housing, a blade assembly and a trimming apparatus. The blade assembly is rotationally mounted on the mower deck housing. The blade assembly includes a blade and a first power input device connected to the blade. The first power input device is configuring for receiving power from a power supply apparatus (i.e., an engine or motor) for urging rotation of the blade. The trimming apparatus includes a main structural body attached to the mower deck housing, a trimming head assembly rotationally attached to the main structural body and a second power input device connected to the trimming head assembly. The second power input device is connected to the first power input device in a manner enabling power from the power supply apparatus to urge rotation of the trimming head assembly.

### FIELD OF THE DISCLOSURE

The disclosures made herein relate generally to equipment for cutting grass and weeds and, more particularly, to apparatuses configured for trimming grass and weeds.

### BACKGROUND

Various types of manually-portable trimming apparatuses configured for using plastic trimming line (i.e., generally referred to as strings) or blade-type cutting devices to edge/trim grass, weeds and the like along obstacles (e.g., driveways, walkways, trees, gardens, etc) are known and widely used. Such apparatuses are hereinafter referred to generally as conventional string trimmers. Conventional string trimmers generally comprise an engine or motor that drives a cutting head carrying plastic trimming line or, optionally, metal or plastic blades. Specific examples of such conventional string trimmers are commercially available from various companies under respective brand names such as Echo, Toro, WeedEater, Black&Decker, Poulan, Ryobi, John Deere, Yard-Man, Makita and Craftsman.

Such conventional string trimmers are known to have drawbacks that adversely affect their effectiveness, desirability and/or practicality. One drawback is that they must be manually carries during use, which requires an operator to expend considerable energy in carrying such trimmers from location to location. Another drawback is that they require that a separate task of trimming a lawn either before or after the lawn is cut with a mower. This is inconvenient in addition to squandering time and energy. Still another drawback is that they represent yet another discrete piece of equipment that must be maintained (e.g., the engine and cutting head).

Therefore, a trimming apparatus that overcomes drawbacks associated with conventional string trimmers would be useful and novel.

### SUMMARY OF THE DISCLOSURE

In one embodiment, a trimming apparatus comprises a main structural body, a trimming head assembly and a power input device. The main structural body has a first portion configured for being attached to a mower deck. The trimming head assembly is rotationally attached to a second portion of the main structural body. The power input device is connected to the trimming head assembly in a manner enabling a power supply apparatus to urge rotation of the trimming head assembly.

In another embodiment, a trimming system configured for being mounted on a mower comprises a trimming apparatus, means for transmitting power and a control unit. The trimming apparatus includes a main structural body having a first portion configured for being attached to a mower deck, a trimming head assembly rotationally attached to a second portion of the main structural body and a power input device connected to the trimming head assembly in a manner enabling a power supply apparatus to urge rotation of the trimming head assembly. The means for transmitting power is configured for transmitting power from a mower deck blade assembly to the power input device of the trimming apparatus. The control unit is configured for enabling power from the power supply apparatus to be selectively transmitted between the trimming head assembly and the power supply apparatus.

In another embodiment, a mower comprises a mover deck housing, a blade assembly and a trimming apparatus. The blade assembly is rotationally mounted on the mower deck housing. The blade assembly includes a blade and a first power input device connected to the blade. The first power input device is configuring for receiving power from a power supply apparatus (i.e., an engine or motor) for urging rotation of the blade. The trimming apparatus includes a main structural body attached to the mower deck housing, a trimming head assembly rotationally attached to the main structural body and a second power input device connected to the trimming head assembly. The second power input device is connected to the first power input device in a manner enabling power from the power supply apparatus to urge rotation of the trimming head assembly.

Correspondingly, it is a principal object of the inventive disclosures made herein to provide a trimming apparatus that overcomes drawbacks associated with conventional string trimmers. Specifically, trimming apparatuses in accordance with embodiments of the inventive disclosures made herein preclude the need to manually carry a separate trimmer, preclude the need for a separate task of trimming a lawn either before or after the lawn is cut with a mower and preclude having to purchase and maintain an additional piece of equipment. Furthermore, trimming apparatuses in accordance with embodiments of the inventive disclosures made herein are preferably configured for being retrofitted on an existing mower deck. Accordingly, trimming apparatuses in accordance with embodiments of the inventive disclosures made herein converse time, money and energy.

Turning now to specific embodiments of the inventive disclosures made herein, in at least one embodiment of the inventive disclosures made herein, a power transmission device is connected to the trimming head assembly.

In at least one embodiment of the inventive disclosures made herein, the power transmission device is configured for selectively transmitting power between the power input device and the trimming head assembly.

In at least one embodiment of the inventive disclosures made herein, a line feeding device is connected to the trimming head assembly.

In at least one embodiment of the inventive disclosures made herein, the line feeding device is configured for dispensing trimming line of the trimming head assembly.

In at least one embodiment of the inventive disclosures made herein, a release mechanism is connected to the main structural body.

In at least one embodiment of the inventive disclosures made herein, the release mechanism is configured for enabling the trimming head assembly to move between a static position and a displaced position with respect to the mower deck.

In at least one embodiment of the inventive disclosures made herein, the release mechanism biases the trimming head assembly to the static position.

In at least one embodiment of the inventive disclosures made herein, means is provided for transmitting power from a mower deck blade assembly to the power input device of the trimming apparatus.

In at least one embodiment of the inventive disclosures made herein, a control unit is provided that is configured for enabling power from a power supply apparatus to be selectively transmitted between a trimming head assembly and the power supply apparatus.

In at least one embodiment of the inventive disclosures made herein, the cutting head assembly carries a spool of trimming line.

In at least one embodiment of the inventive disclosures made herein, the cutting head assembly carries a blade type cutting device.

These and other objects and embodiments of the inventive disclosures made herein will become readily apparent upon further review of the following specification and associated drawings.

### BRIEF DESCRIPTION OF THE DRAWINGS

FIG. 1 depicts a trimming apparatus in accordance with an embodiment of the inventive disclosures made herein.

FIG. 2 depicts the trimming apparatus depicted in FIG. 1 in conjunction with a mower deck of a lawn mower.

FIG. 3 is a side view of the trimming apparatus and mower deck depicted in FIG. 1.

FIG. 4 depicts a main structural body having a release mechanism in accordance with an embodiment of the inventive disclosures made herein.

### DETAILED DESCRIPTION OF THE DRAWINGS

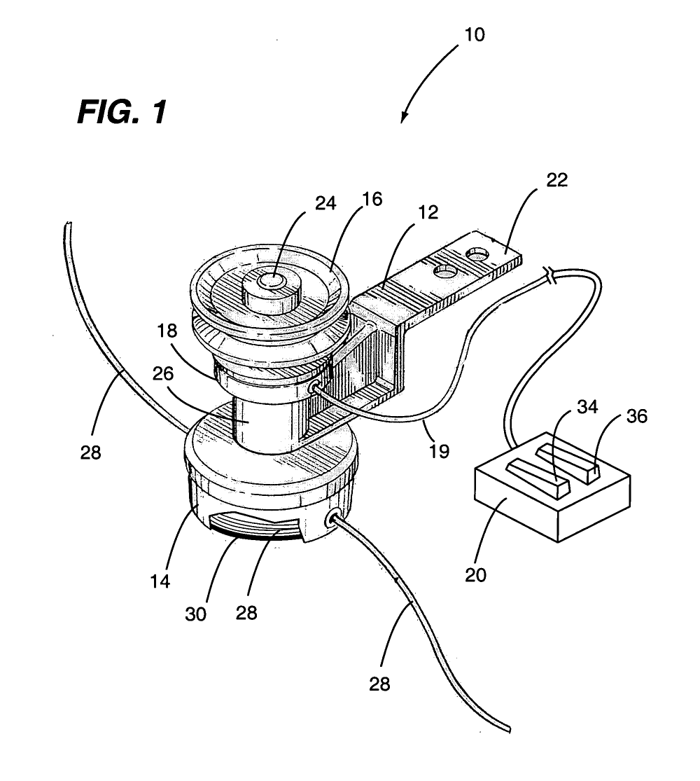

FIG. 1 depicts a trimming apparatus 10 in accordance with an embodiment of the inventive disclosures made herein. The trimming apparatus 10 includes a main structural body 12, a trimming head assembly 14, a pulley 16 (i.e., a power input device), an actuation unit 18 and a control unit 20. The main structural body 12 has a first portion 22 (e.g., a mounting bracket at a first end) configured for being attached to a mower deck. A shaft assembly 24 is rotatable mounted on a second portion 26 (e.g., a shaft-receiving bore at a second end) of the main structural body 12. The pulley 16 is attached to a first end of the shaft assembly 24. The trimming head assembly 14 is attached to a second end of the shaft assembly 24. Thus, the trimming head assembly 14 and the pulley are rotationally attached on the main structural body 12.

The actuation unit 18 is connected between the trimming head assembly 14 and the pulley 16. Preferably, the actuation unit 18 is configured for selectively transmitting power between the pulley 16 and the trimming head assembly 14 and for dispensing trimming line 28 from a spool 30 of the trimming head assembly 14. In one embodiment, the actuation unit 18 includes a power transmission device (not specifically shown) that facilitates transmitting power between the power input device 16 and the trimming head assembly 14 and a line feeding device (not specifically shown) that facilitates dispensing trimming line 28 from a spool 30 of the trimming head assembly 14.

It is contemplated herein that the actuation unit 18 may function according to various constructions. In one embodiment, the power transmission device is connected between the trimming head assembly 14 and the pulley 16 and includes mating members (e.g., hubs) that are coupled to the shaft assembly 24 and an actuating device (e.g., electromagnet, solenoid, servo or the a like) that selectively engages and disengages the mating members. Similarly, in one embodiment, the line feeding device is connected to the spool 30 (e.g., via a sleeve of the shaft assembly 24 that slides on a shaft of the shaft assembly 24) and is configured for axially displacing the spool 30 to release the spool from an anti-rotation device (e.g., as in a conventional string trimmer apparatus), thus enabling trimming line to be dispensed. A skilled person, in view of the inventive disclosures made herein, will contemplate implementation of other constructions of the actuation unit 18 and/or means for provided related functionality.

The pulley 16 receives rotational power from a power supply apparatus via a belt arrangement. In this manner, the power supply apparatus (e.g., a motor or an engine) is able to urge rotation of the trimming head assembly 14. In other embodiments (not shown), the pulley 16 and belt arrangement are at least partially replaced with power transmission means such as one or more chains, gears, driveshafts etc.

The control unit 20 is connected to the actuation unit 18 via a cable 19 for enabling operational control of the actuation unit 18. In one embodiment (as depicted in FIG. 1), the control unit 20 includes a first switch 34 for controlling power transmission functionality and a second switch 36 for controlling line feeding capability. With regard to the first switch 34, the trimming head assembly 14 is engaged with the pulley 16 when the first switch 34 is in a first position thereof and the trimming head assembly 14 is disengaged from the pulley 16 when the first switch 34 is in a second position thereof. With regard to the second switch 36, the trimming line 28 is selectively dispensed from the spool 30 when the second switch 36 is moved from a first position thereof to a second position thereof. The first switch 34 and the second switch 36 are examples of control mechanisms for controlling power transmission and line feeding functionality. A skilled person, in view of the inventive disclosures made herein, will contemplate implementation of other embodiments of such control mechanisms (e.g., levers, push buttons, knobs, etc).

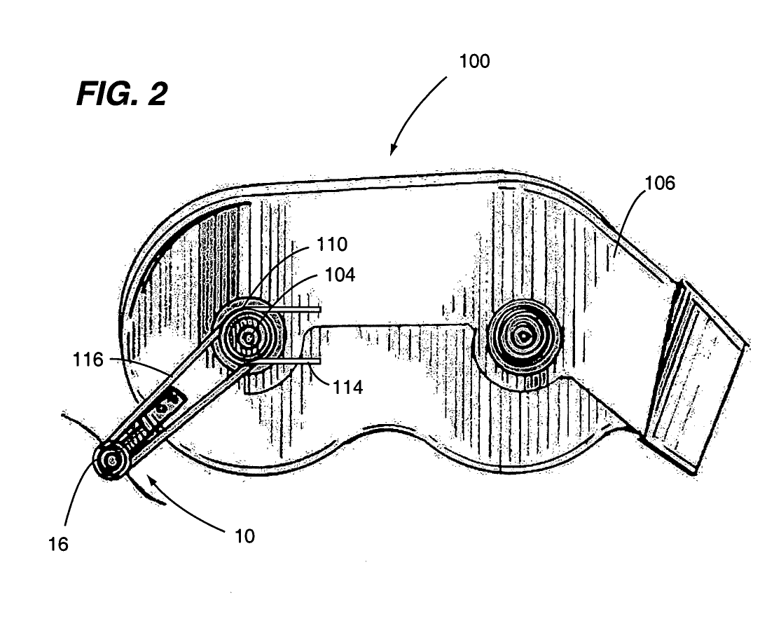

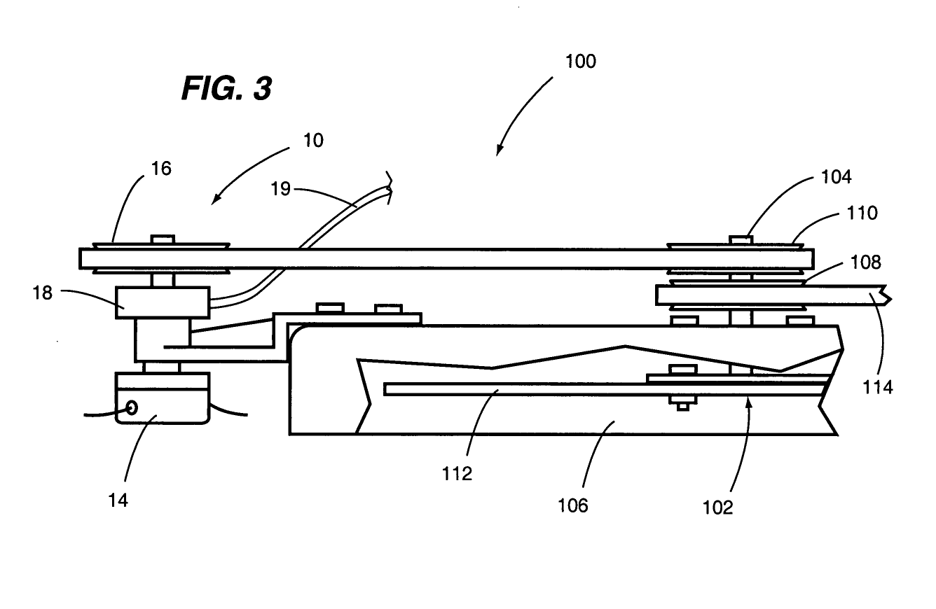

FIGS. 2 and 3 depict a mower deck 100 in accordance with an embodiment of the inventive disclosures made herein. The mover deck 100 is configured with the trimming apparatus 10 depicted in FIG. 1. In this manner, a mower comprising a mower deck such as the mower deck 100 is configured for providing mowing functionality as well as trimming functionality in accordance with embodiments of the inventive disclosures made herein.

The mower deck 100 includes a blade assembly 102 rotationally mounted thereon. The blade assembly 102 includes a shaft 104 rotationally mounted on a housing 106 of the mower deck (i.e., a mower deck housing 106), a first pulley 108 and a second pulley 110 attached to a first end of the shaft 104 and a blade 112 attached to a second end of the shaft 104. In one embodiment, the shaft 104 is mounted in a conventional manner (e.g., via bearings and bearing retainers). The first pulley 108 of the mower deck 100 has a first belt 114 attached thereto for supplying rotational power to the blade assembly 102 for urging rotation of the blade assembly 102. Such power is supplied by an engine or motor (not shown) of a mower (not shown) comprising the mower deck 100.

The pulley 16 of the trimming apparatus 10 is connected to the second pulley 110 of the blade assembly 102 via a second belt 116 for urging rotation of the trimming head assembly. In this manner, the trimming apparatus 10 is connected to the engine or motor. The actuation unit 18 enables power to be selectively transmitted to the trimming head assembly transmitted via the second belt 116.

It is contemplated herein that, in other embodiments (not shown), selective power transmission is facilitated by a power transmission device connected upstream of the pulley 16. For example, it is contemplated that such a power transmission device may a component of the blade assembly 102 rather than of the trimming apparatus 10. Similarly, in another embodiment (not shown), it is contemplated that such a power transmission device may a component of the engine or motor of the mower rather than of the trimming apparatus 10. Such embodiments are examples of means for transmitting power from a power supply apparatus to a power input device (e.g., the pulley 16) of the trimming apparatus.

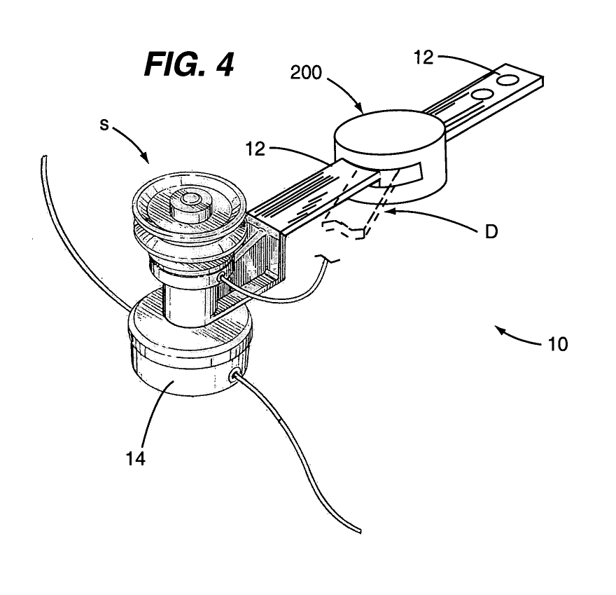

As depicted in FIG. 4, an embodiment of the main structural body 12 includes a release mechanism 200. The release mechanism 200 (e.g., a spring loaded mechanism) is configured for enabling the trimming head assembly 14 to move between a static position S and a displaced position D with respect to an attached mower deck. The release mechanism 200 biases the trimming head assembly 14 to the static position S. Accordingly, when the trimming head assembly 14 (or adjacent portion of the trimming apparatus 10) encounter an essentially immovable obstacle in use, the trimming head assembly 14 is able to pivot upon sufficient contact force. In this manner, the potential for damage to the trimming apparatus 10 and/or the obstacle is reduced.

Certain structural components and/or assemblies of trimming apparatuses in accordance with embodiments of the disclosures made herein may be custom manufactured articles fabricated using known fabrication techniques, proprietary fabrication techniques, commercially available materials and/or proprietary materials. For example, the main structural body may be constructed from steel tubing and/or plate using known operations such as cutting, drilling, turning, milling, die casting, extruding, welding and/or bending using proprietary and/or commercially available equipment. Plastic is another choice for such certain structural components and/or assemblies. Such components and/or assemblies made from plastic may be fabricated using known operations such as molding, extrusion, vacuum forming, cutting, drilling, turning, milling, thermal forming, and/or ultrasonic welding using proprietary and/or commercially available equipment. Furthermore, certain components (e.g., the trimming head assembly, shaft, pulleys actuation unit, control unit, etc) may be off-the-shelf articles (e.g., available from a catalog of articles).

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice embodiments of the inventive disclosures made herein. It is to be understood that other suitable embodiments may be utilized and that logical, mechanical, chemical and electrical changes may be made without departing from the spirit or scope of such inventive disclosures. To avoid unnecessary detail, the description omits certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. A mower, comprising:
a mower deck housing comprising a front, a back and two sides;
a blade assembly rotationally mounted mower deck housing, wherein the blade assembly includes a blade and a first power input device connected to the blade and wherein the first power input device is configuring for receiving power from a power supply apparatus for urging rotation of the blade; and
a trimming apparatus including a main structural body attached to the side of the mower deck housing, a trimming head assembly rotationally attached to the main structural body and a second power input device connected to the trimming head assembly, wherein the second power input device is connected to the first power input device in a manner enabling power from the power supply apparatus to urge rotation of the trimming head assembly.

15. The mower of claim 14, further comprising:
a power transmission device connected between the trimming head assembly and power supply apparatus, wherein the power transmission device is configured for selectively transmitting power between the power supply apparatus and the trimming head assembly.

16. The mower of claim 14 wherein:
the trimming apparatus includes a line feeding device connected to the trimming head assembly; and
the line feeding device is configured for dispensing trimming line of the trimming head assembly.

17. The mower of claim 16, further comprising:
a control unit configured for enabling power from the power supply apparatus to be selectively transmitted between the trimming head assembly and the power supply apparatus and for enabling said trimming line to be selectively dispensed.

18. The mower of claim 14 wherein:
the trimming apparatus further includes a release mechanism connected to the main structural body;
the release mechanism is configured for enabling the trimming head assembly to move between a static position and a displaced position with respect to the mower deck housing;
the release mechanism biases the trimming head assembly to the static position;
and
wherein the release mechanism is configured to allow the trimming head assembly to automatically pivot from its static position to a displaced position when contacted with sufficient force and automatically return pivot to its static position.

19. The mower of claim 14, further comprising:
a power transmission device connected between the trimming head assembly and power supply apparatus, wherein the power transmission device is configured for selectively transmitting power between the power supply apparatus and the trimming head assembly; and
a control unit configured for enabling power from the power supply apparatus to be selectively transmitted between the trimming head assembly and the power input device and for enabling trimming line of the trimming head assembly to be selectively dispensed;
wherein the trimming apparatus includes a line feeding device connected to the trimming head assembly;
wherein the line feeding device is configured for dispensing said trimming line;
wherein the trimming apparatus further includes a release mechanism connected to the main structural body;
wherein the release mechanism is configured for enabling the trimming head assembly to move between a static position and a displaced position with respect to the mower deck housing; and
wherein the release mechanism biases the trimming head assembly to the static position.
